(19) United States
(12) Patent Application Publication
(10) Pub. No.: US 2021/0150164 A1
(43) Pub. Date: May 20, 2021

(54) Systems and Methods of Processing Image Data Using Color Image Sensors

(71) Applicant: ZEBRA TECHNOLOGIES CORPORATION, Lincolnshire, IL (US)

(72) Inventors: Gary G. Schneider, Stony Brook, NY (US); Igor Vinogradov, Oakdale, NY (US); William Sackett, East Setauket, NY (US)

(21) Appl. No.: 16/685,992

(22) Filed: Nov. 15, 2019

(51) Int. Cl. G06K 7/14; G06T 7/90; H04N 9/04; H04N 5/232

(52) U.S. Cl. CPC G06K 7/146; G06T 7/90; G06K 7/1413; H04N 5/23229; G06K 7/1417; H04N 9/0455

(57) ABSTRACT

Systems and methods of processing image data using color image sensors are disclosed herein. An example object scanner includes a color image sensor array configured to produce image data representative of an imaging field of view. The example object scanner also includes an image processor. The image process is configured to separate the image data produced by the color image sensor array into two or more channels of image data and, for each of the channels of image data, analyze the respective image data to determine a contrast of the respective image data. The image processor is also configured to select a particular channel of the two or more channels that has the highest contrast; and output the image data corresponding to the particular channel.

### BACKGROUND

Often, object scanners include a monochrome image sensor. Monochrome image sensors useful when the object scanner is used to scan a typical black and white barcode on a white background. Accordingly, traditional object scanners are tuned to detect the high contrast between black and white. However, not all objects are black on a white background. If the object scanner includes a color imaging sensor, some color combinations may result in the barcode (or other object feature) being undetectable to the traditional object scanner. For example, if there is a cyan barcode on a brown background, there is insufficient contrast between the colors to detect and decode the barcode when subjected to white illumination light. Thus, object scanners with monochrome image sensors are unable to be utilized in scenarios that require processing objects that include certain combinations of target feature color and background color. Therefore, there is a need for systems and method of processing image data using color image sensors.

### SUMMARY

In an embodiment, the present invention is an object scanner. The object scanner may include a color image sensor array configured to produce image data representative of an imaging field of view. Additionally, the object scanner may include an image processor configured to separate the image data produced by the color image sensor array into two or more channels of image data. For each of the channels of image data, the image processor may analyze the respective image data to determine a contrast of the respective image data. Additionally, the image processor may be configured to select a particular channel of the two or more channels that has the highest contrast; and output the image data corresponding to the particular channel.

In a variation of this embodiment, the color image sensor array is configured to sense light in the infrared (IR) spectrum. In this variation, to separate the image data into two or more channels, the image processor is configured to separate IR data from the imaging data produced by the color image sensor array into an IR channel.

In another variation of this embodiment, to separate the image data into two or more channels, the image processor is configured to separate the image data into a red channel, a blue channel, and a green channel. In some variations, to separate the image data into the red channel, the image processor is configured to apply a color filter pattern to the image data produced by the color image sensor array, wherein the color filter pattern includes only the red pattern elements of a color filter pattern applied by the color filter imaging array.

In another variation of this embodiment, the object scanner includes a non-transitory memory configured to store a plurality of color filter patterns. In this variation, to separate the image data into the two or more channels, the image processor is configured to obtain, from the memory, two or more color filter patterns, wherein one of the color filter patterns includes pixels of two or more different colors. For each of the obtained color filter patterns, the image processor may apply the color filter pattern to the image data produced by the color filter imaging array to produce a channel of image data corresponding to the applied color filter pattern.

In another variation of this embodiment, to output the image data corresponding to the particular channel, the image processor is configured to combine the image data in the two or more channels to produce a set of monochrome image data, and output the set of monochrome image data. Additionally, to analyze the respective image data to determine the contrast of the respective image data, the image processor is configured to determine a contrast of the set of monochrome image data.

In the above variation, to combine the image data, the image processor may be configured to apply a respective coefficient to the respective image data in each of the two or more channels; and, based on the applied coefficients, combine the image data in the two or more channels to produce the set of monochrome image data. The object scanner may also include a non-transitory memory configured to store a plurality of sets of coefficients. Accordingly, to apply a respective coefficient to the respective image data in each of the two or more channels, the image processor may be configure to obtain, from the memory, a particular set of coefficients stored at the non-transitory memory; and apply the obtained set of coefficients to the respective image data in each of the two or more channels.

Further, in the above variation, the color image sensor array may be configured to produce a plurality of frames of image data. Additionally, the image processor may be configured to obtain a first set of coefficients stored at the non-transitory memory to apply to a first frame of plurality of frames; and obtain a second set of coefficients stored at the non-transitory memory to apply to a second frame of plurality of frames. Additionally or alternatively, to obtain the particular set of coefficients, the object scanner may be configured to decode a first set of image data produced by the imaging array, the first set of image data including a parameter barcode; and to obtain, from the non-transitory memory, a set of coefficients corresponding to the parameter barcode.

Still further, in the above variation, the color image sensor array may be configured to produce a plurality of frames of image data. Accordingly, to apply the respective coefficient to the respective image data in each of the two or more channels, the image processor may be configured to, for a first frame of image data, (1) apply a first set of coefficients to the respective image data in each of the two or more channels, (2) based on the first set of coefficients, combine the image data in the two or more channels to produce a first set of monochrome image data, and (3) analyze the first set of monochrome image data to determine a coefficient adjustment to improve a contrast of produced monochrome image data. For a subsequent frame of image data, the image processor may be configured to, based upon the determined coefficient adjustment, apply a second set of coefficients to the respective image data in each of the two or more channels, and based on the second set of coefficients, combine the image data in the two or more channels to produce a second set of monochrome image data.

In another variation of this embodiment, the object scanner includes a decoder configured to decode the selected set of image data. For example, the decoder may be configured to detect a presence of a barcode within the set of image data.

In another variation of this embodiment, the object scanner includes a machine vision module configured to detect a presence of one or more target features within the selected set of image data. For example, the target feature may be a pin soldering quality or a crack in an object surface.

In another embodiment, the present invention is a method of processing image data. The method may include producing, via a color image sensor array, image data representative of an imaging field of view. Additionally the method may include separating, via an image processor, the produced image data into two or more channels of image data and, for each of the channels of image data, analyzing, via the image processor, the respective image data to determine a contrast of the respective image data. The method may also include selecting, via the image processor, a particular channel of the two or more channels that has the highest contrast; and outputting, via the image processor, the image data corresponding to the particular channel.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1A illustrates front and rear perspective views of an object scanner, in accordance with an embodiment of the present invention.

FIGS. 1B and 1C are example environments where the object scanner of FIG. 1A is used to scan a barcode and pin soldering, respectively, in accordance with an example.

FIGS. 2A and 2B illustrate example image data when using a traditional monochrome object scanner to scan color barcodes.

FIG. 3 illustrates example image data when using the object scanner of FIG. 1A to scan a cyan barcode on a brown background.

FIG. 4A illustrates an example flowchart for a process for separating the color image data produced by a color image sensor of the object scanner of FIG. 1A into respective channels, in accordance with an example embodiment of the object scanner of FIG. 1A.

FIG. 4B illustrates an example flowchart for a process for separating the color image data produced by a color and infrared image sensor of the object scanner of FIG. 1A into respective channels, in accordance with an example embodiment of the object scanner of FIG. 1A.

FIG. 5 illustrates an example flowchart for a process for combining the respective channels of FIGS. 4A and 4B to produce a composite channel of image data, in accordance with an example embodiment of the object scanner of FIG. 1A.

FIG. 6 illustrates an example flowchart for a process for selecting a channel of image data for processing, in accordance with an example embodiment of the object scanner of FIG. 1A.

FIG. 7 illustrates an example flowchart for a process for selecting a channel of image data for processing using autotuning, in accordance with an example embodiment of the object scanner of FIG. 1A.

FIG. 8 is a block diagram of an example logic circuit implemented at the example object scanner of FIG. 1A.

FIG. 9 is a flow chart of an example method for processing image data using the object scanner of FIG. 1A.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

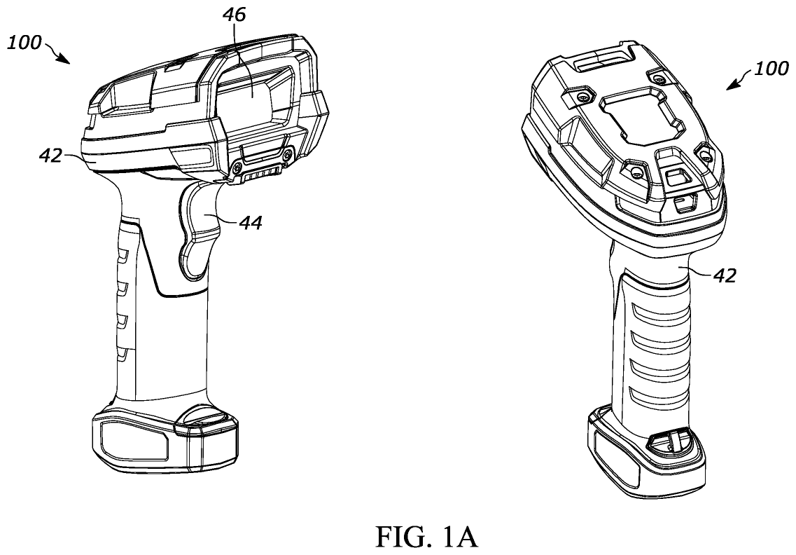

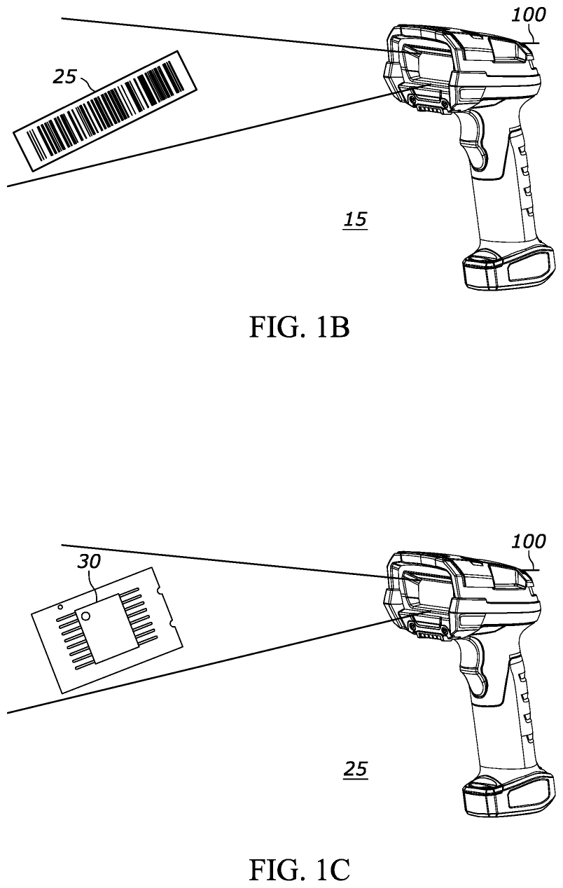

Referring to FIG. 1A, shown therein is an exemplary object scanner 100 having a housing 42 with a cavity for housing internal components, a trigger 44, and a window 46. The object scanner 100 can be used in a hands-free mode as a stationary workstation when it is placed on the countertop in a supporting cradle (not shown). The object scanner 100 can also be used in a handheld mode when it is picked up off the countertop (or any other surface) and held in an operator's hand. In the hands-free mode, products can be slid, swiped past, or presented to the window 46. In the handheld mode, an imaging field of view of an image sensor of the object scanner 100 can be aimed at a barcode on a product, and the trigger 44 can be manually depressed to initiate imaging of the barcode.

Referring now to FIG. 1B, illustrated is an example environment 15 where the object scanner 100 is used to read a barcode 25. The barcode 25 may encode information using a one-dimensional, two-dimensional pattern, and/or three-dimensional pattern. Generally, the barcode 25 encodes information about an object on which the barcode 25 resides, such as serial number, a part number, or another identifier of the object, a manufacturing date and/or location of the object, and/or a manufacturer of the object.

Referring now to FIG. 1C, illustrated is an example environment 25 where the object scanner 100 is used to analyze an object 30. In the illustrated example, the object scanner 100 is used to scan a microchip affixed to a printed circuit board. More particularly, the object scanner 100 is configured to detect whether the pins of the microchip are properly soldered to the printed circuit board. Of course, the object scanner 100 may be utilized to scan other features of other objects. For example, the object scanner 100 may also be used to detects cracks on the object 300, and/or other object features.

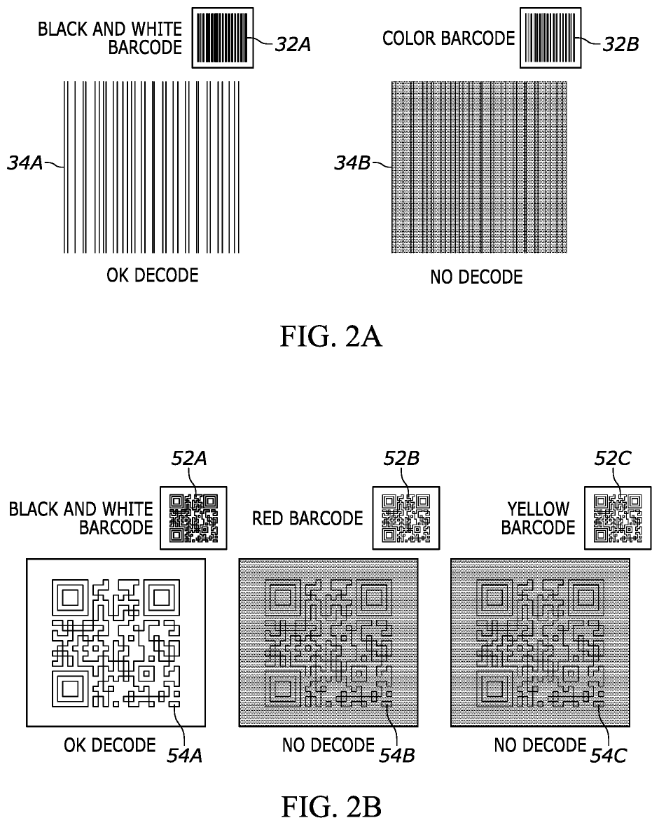

FIGS. 2A and 2B illustrate example image data when using a traditional monochrome object scanner to scan color barcodes. In particular, FIG. 2A illustrates example image data 34 representative of 1-D barcodes 32 and FIG. 2B illustrates example image data 54 representative of 2-D barcodes 54. Generally, traditional monochrome object scanners are not optimized to read color barcodes. Accordingly, while the traditional monochrome object scanner is able to produce image data 34a with sufficient contrast as to be able to decode the black and white barcode 32a, the image data 34b does not have sufficient contrast as to be able to decode the red barcode 32b. Similarly, as illustrated in FIG. 2B, the traditional monochrome object scanner is able to produce image data 54a with sufficient contrast as to be able to decode the black and white barcode 52a, the image data 54b and 54c lacks sufficient contrast to enable the traditional monochrome object scanners to decode the red barcode 52b and yellow barcode 52c, respectively.

Prior solutions to improve the contrast in traditional monochrome object scanners involved using color illumination assemblies. However, this solution requires including different color illumination assemblies for each application that requires scanning a different color. Accordingly, the prior color illumination assembly approach is not adaptable to multiple purposes.

On the other hand, the presently disclosed techniques involve using a color image sensor and separating the color image data into different channels in the imaging pipeline. As a result, an object scanner may still only include a white illumination assembly (or white and infrared) and be able to produce image data with sufficient contrast as to enable the present object scanners to decode barcodes printed in a wide range of colors on various different background colors.

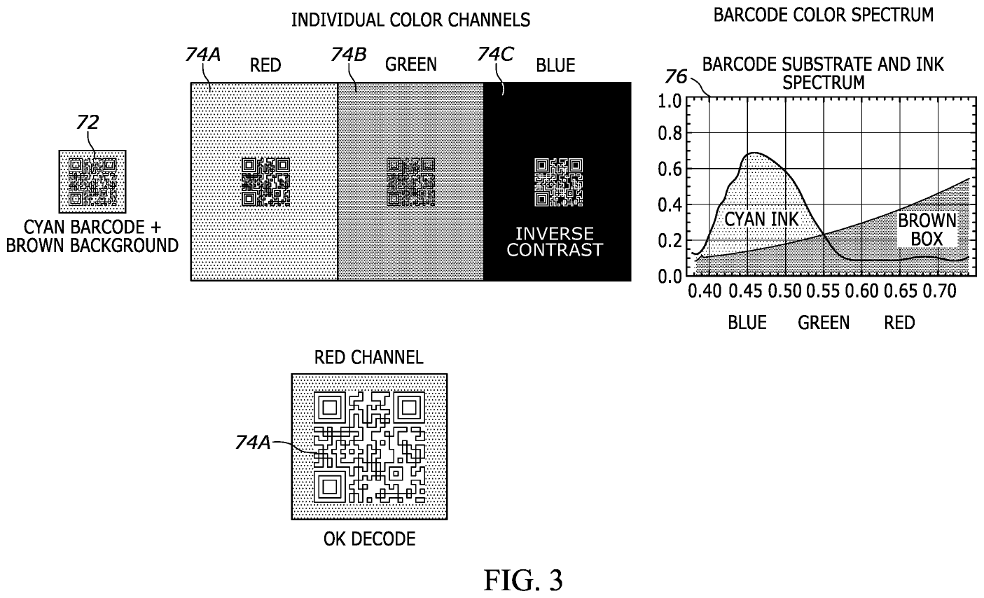

To this end, FIG. 3 illustrates example image data when using the object scanner of FIG. 1A to scan a cyan barcode 72 on a brown background. Using the techniques disclosed herein, the object scanner 100 separates the image data into a red channel of image data 74a, a green channel of image data 74b, and an inverted blue channel of image data 74c. As shown on the graph 76, the contrast (i.e., the difference in intensity when subjected to light of a particular wavelengths) between the cyan barcode and the brown background is large in the blue and red ranges of wavelengths but small in the green range of wavelengths. Accordingly, the image data 74a produced via the red channel and the image data 74c produced by the blue channel provide sufficient contrast as to enable the object scanner to decode the cyan barcode 72. On the other hand, the image data 74b produced via the green channel lacks sufficient contrast as to enable the object scanner 100 to decode the cyan barcode 72. Consequently, the object scanner 100 can pass the image data 74a or 74c onto a decoder that is able to successfully determine the information encoded by the cyan barcode 72.

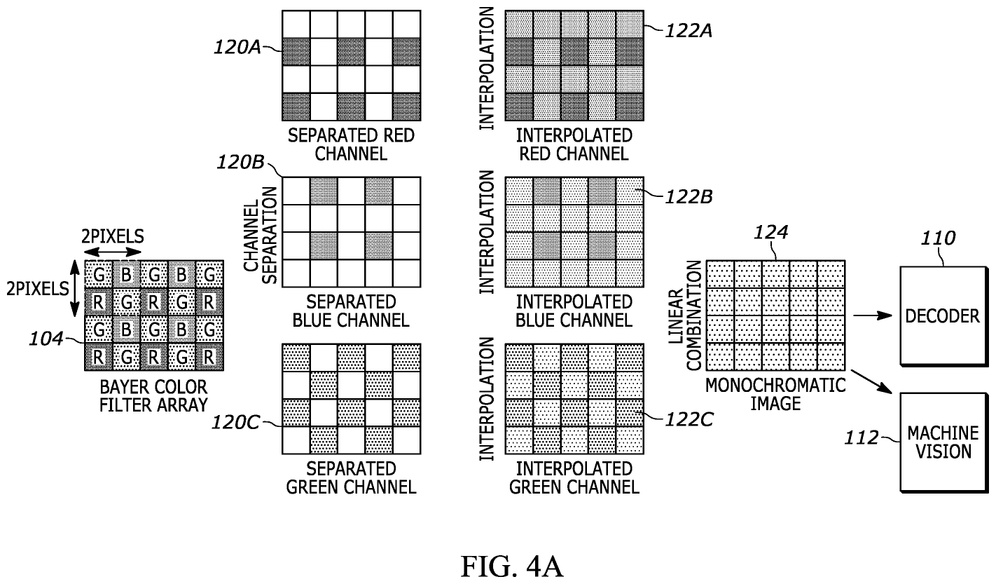

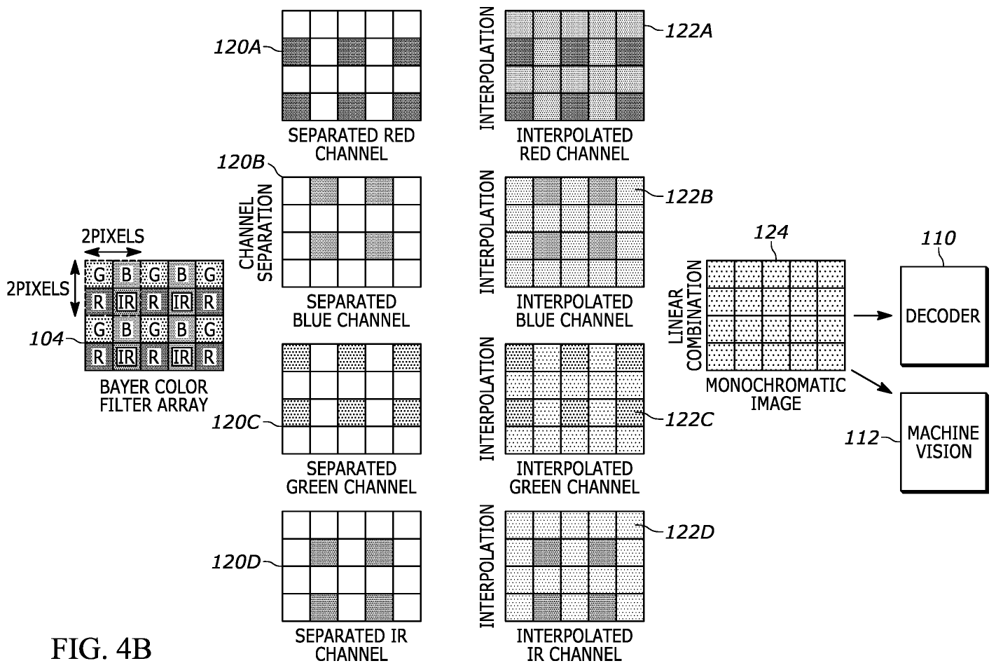

FIG. 4A illustrates an example an example flowchart for a process for separating the color image data produced by a color image sensor of the object scanner 100 of FIG. 1A into respective channels. The image sensor of the object scanner 100 may be an array of photodetectors, wherein each photodetector is associated with a respective color filter forming a Bayer pattern or color filter array 104. In the illustrated example, the Bayer pattern 104 is the 2×2 matrix

$$[ \begin{matrix}G & B \\ R & G\end{matrix} ]$$

where G is representative of a light filter that passes the green spectrum of light, B is representative of a light filter that passes the blue spectrum of light, and R is representative of a light filter that passes the red spectrum of light. Of course, the Bayer pattern 104 is one example Bayer pattern that may be implemented at the image sensor of the object scanner 100. Other embodiments, may implement different Bayer patterns.

It should be appreciated that the object scanner may be configured to store an indication the Bayer pattern 104. Using this indication, an image processor of the object scanner 100 is able to separate the image data into one or more channels of image data 120. In particular, the image processor may identify the photodetectors associated with a red filter (the “R” pixels) and separate the corresponding image data into the channel 120a. Because the image data 120a is missing the image data associated with the “G” and the “B” pixels, the image processor applies interpolation techniques to the image data 120a to produce the interpolated image data 122a. In one example, the interpolation technique is the application of a 3×3 linear demosaic image convolution kernel matrix of

$$[ \begin{matrix}1 & 1 & 1 \\ 1 & 0 & 1 \\ 1 & 1 & 1\end{matrix} ] .$$

As other examples, the interpolation technique may be a non-linear or bi-linear demosaic matrix, a nearest pixel demosaic matrix, a median demosaic matrix, and/or other interpolation techniques. The image processor may also separate the image data produced by the image sensor into a blue channel 120b and green channel 120c and apply the interpolation technique to produce the interpolated image data 122b and 122c, respectively.

While the illustrated example depicts separating the red, green, and blue data into respective channels of image data, in some embodiments, a channel may be produced using pixels of two or more of the colors. For example, the image processor may separate the image data into a channel using some of the “R” pixels and some of the “B” pixels. Additionally, alternate Bayer patterns may utilize different colors to form the Bayer pattern.

After the image processor separates the image data into the interpolated channels of image data, the image processor produces a set of monochromatic image data 124. In some embodiments, the monochromatic image data 124 is representative of the channel 122a-c that exhibits the highest contrast. In other embodiments, the monochromatic image data 124 is produced by combining two or more of the channels 122a-c. The process for combining two or more channels is described in further detail below.

After producing the set of monochromatic image data 124, the image processor routes the monochromatic image data 124 to a decoder 110 and/or a machine vision module 112. In some embodiments, the decoder 110 is configured to analyze the monochromatic image data 124 to detect the presence of a barcode therein. If the decoder 110 detects the presence of a barcode, the decoder 110 decodes the barcode to determine the underlying data conveyed by the barcode. In some embodiments, the machine vision module 112 is configured to analyze the monochromatic image data 124 to detect one or more target features of an object (e.g., proper pin soldering, a crack, etc.). The object scanner 110 may be configured to convey information to a user via one or more user interfaces based on the analyses performed by the decoder 110 and/or the machine vision module 112.

FIG. 4B illustrates an example an example flowchart for a process for separating the color image data produced by a color and infrared image sensor of the object scanner 100 of FIG. 1A into respective channels. In this example, the image sensor array includes photodetectors with light filters configured to pass light within the infrared spectrum. Accordingly, in this example, the illumination assembly of the object scanner 100 may be configured to produce illumination light that includes the infrared spectrum. As illustrated, the Bayer pattern 104 for this example object scanner 100 is the 2×2 matrix

$$[ \begin{matrix}G & B \\ R & IR\end{matrix} ]$$

where IR is representative of a light filter that passes the IR spectrum of light.

In the example illustrated in FIG. 4B, the image processor still produces the interpolated red channel 122a, the interpolated blue channel 122b, and the interpolated green channel 122c as described with respect to FIG. 4A. However, the image processor is additionally configured to separate the “IR” pixels into an IR channel 120d and apply the interpolation technique to produce the interpolated IR channel 122d. Thus, when the image process selects the channel with the highest contrast and/or combines the channels 122 to produce the monochromatic image data 124, the image processor also analyzes the interpolated IR channel 122d.

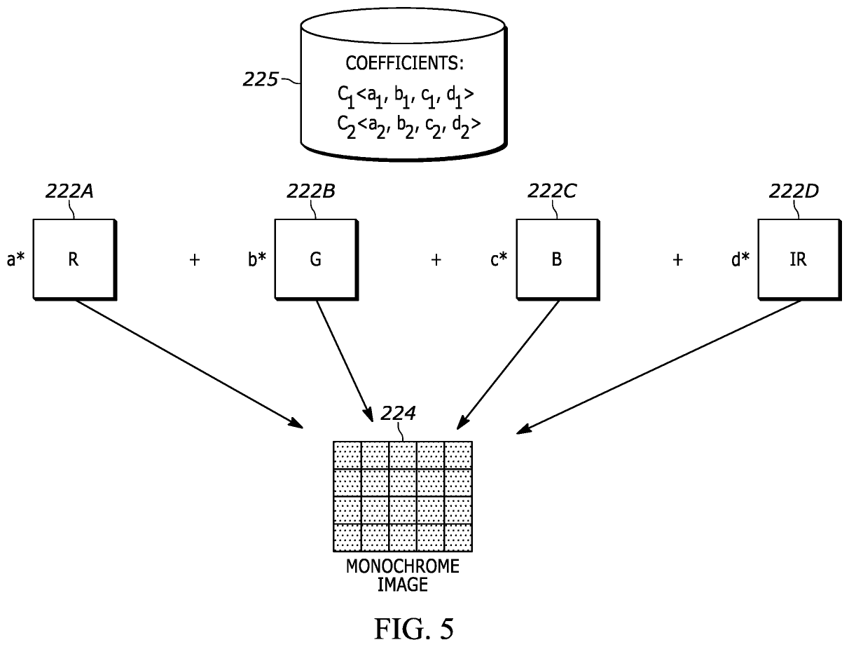

FIG. 5 illustrates an example flowchart for a process for combining the respective channels of FIGS. 4A and 4B to produce a composite channel of image data 224. As illustrated, the object scanner 100 include a database of coefficient sets 225. Each set of coefficients includes a respective coefficient for each of the channels 222 generated by separating a set image data produced by an image sensor of the object scanner 100. The coefficient may be a weight that is used to scale the image data in the respective channel 222 (e.g., the first coefficient “a” scales the red channel 22a, the second coefficient “b” scales the green channel 222b, the third coefficient scales the blue channel 222c, and the fourth coefficient “d” scales the IR channel 222d). The scaled image data in the respective channels may then be combined using linear combination techniques to produce the composite channel of image data 224. In some embodiments, a balancing factor may be applied to the composite channel of image data 224 and/or the component scaled image data to ensure that the composite channel of image data exhibits a level of brightness within a predetermined range.

In some embodiments, a coefficient may be 0 to indicate that the respective channel 222 does not influence the composite channel of image data 224. In some embodiments, a coefficient may be negative such that the respective channel 222 inversely influences the composite channel of image data 224. It should be appreciated that while the illustrated example depicts four coefficients respectively corresponding to the four channels 222a-d, other embodiments that implement a different number of channels 222 may have coefficient sets having a different number of coefficients.

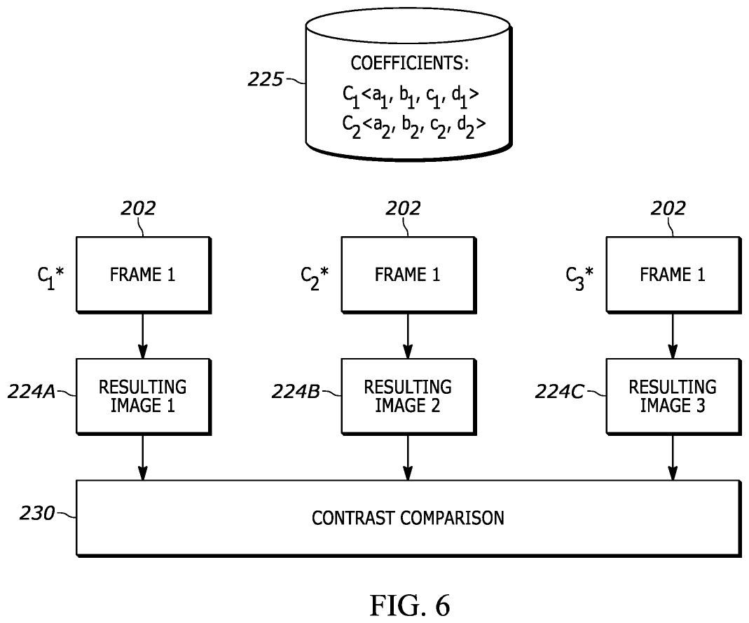

FIG. 6 illustrates an example an example flowchart for a process for selecting a channel of image data 224 for processing, in accordance with an example embodiment of the object scanner 100 of FIG. 1A. In the example process, the object scanner 100 applies multiple sets of coefficients stored at the coefficient database 225 to a frame of image data 202 produced by the image sensors of the object scanner 100. For each set of coefficients applied to the frame of image data 202, the object scanner 100 produces a respective set of image data 224. In some embodiments, the object scanner 100 implements parallel processing techniques to produce the set of image data 224 in parallel.

In some embodiments, the database 225 includes one or more prioritized list of coefficient sets. For example, the highest priority coefficient sets may be ones that include a single one of the red, blue, green, or IR channels (e.g., <1,0,0,0>, <0,1,0,0>, <0,0,1,0>, or <0,0,0,1>). As another example, the object scanner 100 may include a user interface (e.g., a graphical user interface, buttons, toggles, etc.) that enables the user to select a mode of operation and/or a type of object that will be scanned. Based on the user input, the object scanner 100 may identify a prioritized set of coefficients that is associated with the indicated mode of operation. In some embodiments, the object scanner 100 is configured to scan a parameter barcode to determine the applied coefficient sets. For example, the parameter barcode may be formatted to instruct the object scanner 100 to apply a particular set of coefficients to captured frames of image 202 and/or to identify a particular prioritized list of coefficient sets associated with a particular mode of operation. While the illustrated example shows the object scanner 100 applying three different sets of coefficients to the frame of image data 202, the object scanner 100 may apply any number of coefficient sets to the frame of image data 202 to produce a respective set of image data 224.

After the object scanner 100 produces the sets of image data 224, the object scanner 100 analyzes the sets of image data 224 to determine the contrast (block 230) exhibited by each set of image data 224. In some embodiments, the object scanner 100 determines the contrast by measuring the intensity difference between the highest intensity pixel and the lowest intensity pixel for each set of image data 224. Accordingly, the object scanner 100 may select the set of image data 224 with the highest contrast to output for further processing by a decoder and/or a machine vision module. In some scenarios, the set of image data 224 with the highest contrast may still lack sufficient contrast to be properly analyzed by the decoder and/or the machine vision module. Accordingly, the object scanner 100 may be configured to compare the contrast of the selected set of image data 224 to a threshold level of contrast. If the contrast exceeds the threshold, then the object scanner 100 passes the set of image data on for further processing by the decoder and/or the machine vision module. If not, the object scanner 100 may apply a different set of coefficients to a subsequent frame of image data 202 and/or begin an autotuning process.

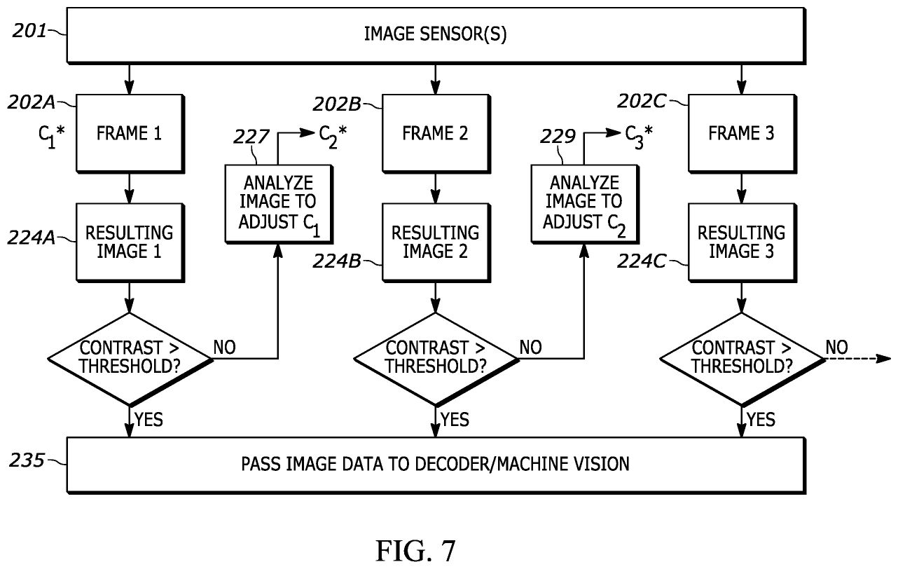

FIG. 7 illustrates an example flowchart for a process for selecting a channel of image data for processing using autotuning, in accordance with an example embodiment of the object scanner 100 of FIG. 1A. In some embodiments, the autotuning process may begin when the object scanner 100 is unable to produce a set of image data 224 that meets a threshold contrast following the techniques described with respect to FIG. 6. In other embodiments, the object scanner 100 may begin the autotuning process upon producing a set of image data via the image sensors 201.

As illustrated, the object scanner 100 is configured to apply a set of coefficients C1 to a first frame of image data 202a produced by the image sensors 201 to generate a resulting set of image data 224a. In some embodiments, the set of coefficients C1 is determined based upon a prioritized list of coefficients obtained from a memory, such as the database 225 of FIG. 6. In other embodiments, the database 225 may store a set of coefficients known to be fairly good for providing sufficient contrast under certain operating conditions to provide an effective starting point for the tuning process. It should be appreciated that while FIG. 7 depicts a single set of coefficients C1 being applied to the frame of image data 202 to produce the resulting set of image data 224, other embodiments may apply the techniques described with respect to FIG. 6 to apply a plurality of sets of coefficients to the frame of image data 202 and select the resulting image data with the highest contrast to server as the resulting set of image data 224.

After the object scanner 100 produces the first resulting set of image data 224a, the object scanner 100 may be configured to compare the contrast of the image data 224a to a threshold level of contrast. If the contrast exceeds the threshold, the object scanner may pass the first resulting set of image data 224a on to a decoder and/or a machine vision module for further analysis. On the other hand, if the contrast of the image data 224a is below the threshold, the object scanner 100 may be configured to analyze the image data 224a to determine an adjustment to the set of coefficients C1 to improve the contrast of a subsequent set of resulting mage data (i.e., tune the set of coefficients). For example, if the object scanner 100 detected relatively high contrast in the red and green channel (e.g., channels 122a and 122c of FIG. 4) and low contrast in the blue channel (e.g., channel 122b of FIG. 4), the object scanner 100 may increase the coefficient corresponding to the red channel and/or the coefficient corresponding to the green channel, and decrease the coefficient corresponding to the blue channel.

After the object scanner 100 adjusts the set of coefficients C1 to produce a new set of coefficients C2, the object scanner 100 may the apply the set of coefficients C2 to a second frame image data 202b produced by the image sensors 201 to generate a second resulting set of image data 22b. To this end, when a user of the object scanner 100 holds down the trigger 44, the image sensor 201 may be configured to produce a series of frames of image data 202. For example, the image sensors 201 may be configured to produce 30 frames of image data per second. Accordingly, the object scanner 100 may be able to analyze a first frame of image data 202a and apply adjusted coefficients C2 to a second frame of image data 202b in a time frame that is not perceptible to humans. It should be appreciated that while the second frame of image 202b is produced subsequent to the first frame of image 202a, the second frame of image data 202b may not be the next sequential frame of image data after the first frame of image data 202a.

The object scanner 100 may then be configured to analyze the second resulting set of image data 224b to determine a contrast thereof. Accordingly, the object scanner 100 may compare to the contrast of the second resulting set of image data 224b to the threshold level of contrast. If the contrast exceeds the threshold, the object scanner 100 may pass the second resulting set of image data 224b on for further analysis by a decoder and/or a machine vision module. On the other hand, if the contrast of the second resulting set of image data 224b is still below the threshold, the object scanner 100 may be configured to determine an adjustment to the set of coefficients C2 to produce a set of coefficients C3 (block 229). The object scanner 100 may determine the adjustment in the same manner that produce the set of coefficients C2 at block 227. Accordingly, the object scanner 100 may apply the set of coefficients C3 to a third frame of image data 202c produced by the image sensors 201 to generate a third set of resulting image data 224c. This loop of adjusting the coefficients Ci and applying the new set of coefficients to a subsequent frame of image data may continue until a set of resulting image data 224 exceeds the threshold level of contrast.

By combining the channels of image data in the manner described with respect to FIGS. 6 and 7, the contrast of the resulting image data 224 is increased. As a result, it is more likely that a decoder and/or a machine vision module is able to accurately detect barcodes and/or target features. Accordingly, the object scanner 100 is able to accurately scan more types of objects in a wider variety of operating conditions.

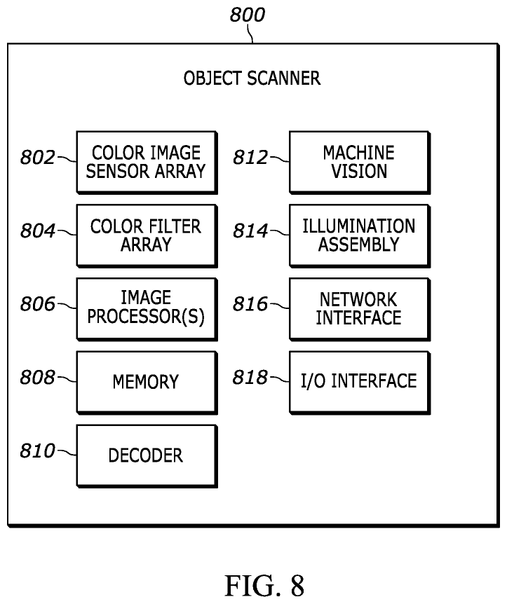

FIG. 8 is an example logic circuit implemented at an example object scanner 800, such as the object scanner 100 of FIG. 1A. In the illustrated example, the object scanner 800 includes a color image sensor array 802 generally configured to sense image data within a field of view thereof. More particularly, the a color image sensor array 802 may be an array of image sensors configured to detect light that reflected off an object of interest within the imaging field of view. The color image sensor array 802 may be associated with a color filter array 804 that include color filters respectively associated with the individual image sensors of the color image sensor array 802. For example, a first image sensor of the color image sensor array 802 may be associated with a green filter and a second image sensor of the color image sensor array 802 may be associated with a red filter. The pattern of color filters that form the color filter array 804 may be a Bayer pattern.

As illustrated, the object reader 800 also includes an illumination assembly 814 configured to produce an illumination light directed toward the imaging field of view of the color image sensor array 802. For example, the illumination assemblies 814 may include one or more light emitting diodes (LEDs) or other types of light sources. In some embodiments, the illumination assembly 814 is configured to emit white light (e.g., light that includes wavelengths across the entire visible spectrum). Thus, the color image sensor array 802 is capable of sensing the full range of light reflections.

As described above, traditional object scanners that only include monochrome image sensors (e.g., object scanners that don't include the color filter array 804) utilize color illumination light to enable the image sensor array to sense image data associated with different colors. However, such techniques require complex circuitry if the color illumination assembly is to be adapted for multiple uses. Thus, the techniques described herein enable the use of a simpler illumination assembly 814 that does not include the various components needed to tune color illumination light for a particular purpose. Moreover, these techniques do not produce the wide range of image data that assist in the autotuning process described with respect to FIG. 7. Thus, these traditional object scanners are unable to automatically adapt the image processing pipeline to improve the contrast of the image data.

The example object scanner 800 also include one or more image processors 806 capable of executing instructions to, for example, implement operations of the example methods described herein, as may be represented by the flowcharts of the drawings that accompany this description. The image processors 806 may be one or more microprocessors, controllers, and/or any suitable type of processor. Other example image processors 806 capable of, for example, implementing operations of the example methods described herein include field programmable gate arrays (FPGAs) and application specific integrated circuits (ASICs).

The example object scanner 800 includes memory (e.g., volatile memory, non-volatile memory) 808 accessible by the image processors 806 (e.g., via a memory controller). The example image processors 806 interacts with the memory 808 to obtain, for example, machine-readable instructions stored in the memory 808 corresponding to, for example, the operations represented by the flowcharts of this disclosure. Additionally or alternatively, machine-readable instructions corresponding to the example operations described herein may be stored on one or more removable media (e.g., a compact disc, a digital versatile disc, removable flash memory, etc.) that may be coupled to the object scanner 800 to provide access to the machine-readable instructions stored thereon. Additionally, the memory 808 may also include storage for the various types of data described herein. For example, the memory 808 may include storage for one or more color filter patterns used to demosaic image data produced by color image sensor array 802 and/or the database of coefficients 225 of FIG. 5.

The example object scanner 800 also includes a decoder 810 and a machine vision module 812 configured to analyze sets of image data (such as the resulting sets of image data 224 of FIGS. 6 and 7) that have been processed by the image processors 806. The example decoder 810 is configured to determine whether the image data is representative of a barcode, and if so, decode the barcode to determine the encoded information. The example machine vision module 812 is configured to perform object recognition techniques on the image data to identify target features thereof. For example, the machine vision module 812 may be configured to detect target features such as cracks on an object and/or an incomplete soldering connection for a pin of a microchip.

The example object scanner 800 also includes a network interface 816 to enable communication with other machines via, for example, one or more networks. The example network interface 816 includes any suitable type of communication interface(s) (e.g., wired and/or wireless interfaces) configured to operate in accordance with any suitable protocol(s).

The example, processing platform 818 also includes input/output (I/O) interfaces 818 to enable receipt of user input and communication of output data to the user. For example, the output data may be the encoded information determined by the decoder 810 and/or an indication of the features detected by the machine vision module 812.

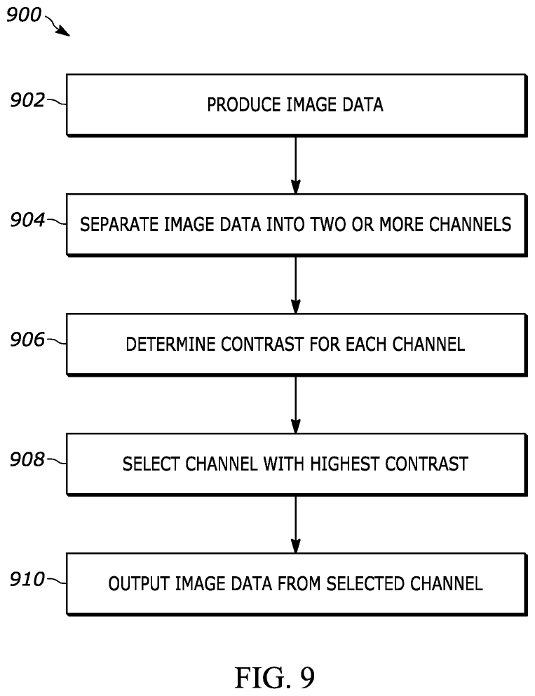

FIG. 9 is a flow chart of an example method 900 for processing image data using an object scanner, such as the object scanner 100 of FIG. 1A and/or the object scanner 800 of FIG. 8. For example, the method 900 may be performed by the image processors 806 of the object scanner 800 executing a set of processor-executable instructions stored at the memory 808.

The method 900 begins at block 902 when the object scanner produces a set of image data using a color image sensor array (such as the color image sensor array 802 of FIG. 8). The color image sensor array 902 of the object scanner 800 may be configured to periodically (e.g., sixty times a second, thirty times a second, twenty four times a second, ten times a second, five times a second, every second) produce a frame of image data. In some embodiments, the image processors 806 are configured to trigger the color image sensor array 802 to produce the frame of image data.

At block 904, the image processors 806 are configured to separate the image data into two or more channels. For example, as described with respect to FIGS. 4A and 4B, the image processors 806 may apply one or more color filter patterns to demosaic the frame of image data into a red channel, a blue channel, a green channel, and/or an infrared channel. In some embodiments, the image processors 806 apply a hybrid demosaic technique to produce a channel of image data that includes two or more component filter types of the Bayer pattern implemented by the color filter array 804. In some embodiments, the image processors 806 apply an interpolation technique to the channels of image data to produce corresponding image data for the channel. In some embodiments, such as those described with respect to FIGS. 5 and 6, the image processors 806 apply a set of coefficients to combine two or more of the channels of image data to produce a composite channel of image data.

At block 906, the image processors 806 are configured to determine a contrast for each channel of image data. In some embodiments, this includes determining the contrast for a composite channel of image data.

At block 908, the image processors 806 are configured to select the channel with the highest amount of contrast. It should be appreciated that for some color combinations the contrast calculation may produce a negative number in some channels. Accordingly, the image processors 806 may be configured to compare a magnitude of the determined contrasts to select the channel with the highest amount of contrast. In some embodiments, the image processors 806 compares the contrast for the selected channel to a threshold level of contrast. If the contrast for the selected channel is below the threshold level of contrast, the image processors 806 may apply the autotuning techniques described with respect to FIG. 7.

At block 910, the image processors 806 may output the image data from the selected channel. In some embodiments, the image processors 806 outputs the image data from the selected channel by routing the image data to a decoder (such as the decoder 810 of FIG. 8) and/or a machine vision module (such as the machine vision module 612 of FIG. 8). In embodiments where the contrast is a negative value for the selected channel, the image processors 806 may invert the image data from the selected channel before routing the image data to the decoder and/or the machine vision module. Additionally or alternatively, the image processors 806 may output the image data to an I/O interface (such as the I/O interface 818 of FIG. 8) and/or to another machine via the network interface (such as the network interface 816 of FIG. 8).

The above description refers to a block diagram of the accompanying drawings. Alternative implementations of the example represented by the block diagram includes one or more additional or alternative elements, processes and/or devices. Additionally or alternatively, one or more of the example blocks of the diagram may be combined, divided, re-arranged or omitted. Components represented by the blocks of the diagram are implemented by hardware, software, firmware, and/or any combination of hardware, software and/or firmware. In some examples, at least one of the components represented by the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICs or FPGAs, are specifically configured hardware for performing operations (e.g., one or more of the operations described herein and represented by the flowcharts of this disclosure, if such are present). Some example logic circuits are hardware that executes machine-readable instructions to perform operations (e.g., one or more of the operations described herein and represented by the flowcharts of this disclosure, if such are present). Some example logic circuits include a combination of specifically configured hardware and hardware that executes machine-readable instructions. The above description refers to various operations described herein and flowcharts that may be appended hereto to illustrate the flow of those operations. Any such flowcharts are representative of example methods disclosed herein. In some examples, the methods represented by the flowcharts implement the apparatus represented by the block diagrams. Alternative implementations of example methods disclosed herein may include additional or alternative operations. Further, operations of alternative implementations of the methods disclosed herein may combined, divided, re-arranged or omitted. In some examples, the operations described herein are implemented by machine-readable instructions (e.g., software and/or firmware) stored on a medium (e.g., a tangible machine-readable medium) for execution by one or more logic circuits (e.g., processor(s)). In some examples, the operations described herein are implemented by one or more configurations of one or more specifically designed logic circuits (e.g., ASIC(s)). In some examples the operations described herein are implemented by a combination of specifically designed logic circuit(s) and machine-readable instructions stored on a medium (e.g., a tangible machine-readable medium) for execution by logic circuit(s).

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) are stored for any suitable duration of time (e.g., permanently, for an extended period of time (e.g., while a program associated with the machine-readable instructions is executing), and/or a short period of time (e.g., while the machine-readable instructions are cached and/or during a buffering process)). Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device” can be read to be implemented by a propagating signal.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

The claims are:

1. An object scanner comprising:
a color image sensor array configured to produce image data representative of an imaging field of view; and
an image processor configured to:
separate the image data produced by the color image sensor array into two or more channels of image data;
for each of the channels of image data, analyze the respective image data to determine a contrast of the respective image data;
select a particular channel of the two or more channels that has the highest contrast; and
output the image data corresponding to the particular channel.

2. The object scanner of claim 1, wherein:
the color image sensor array is configured to sense light in the infrared (IR) spectrum, and
to separate the image data into two or more channels, the image processor is configured to:
separate IR data from the imaging data produced by the color image sensor array into an IR channel.

3. The object scanner of claim 1, wherein to separate the image data into two or more channels, the image processor is configured to:
separate the image data into a red channel, a blue channel, and a green channel.

4. The object scanner of claim 3, wherein to separate the image data into the red channel, the image processor is configured to:
apply a color filter pattern to the image data produced by the color image sensor array, wherein the color filter pattern includes only the red pattern elements of a color filter pattern applied by the color filter imaging array.

5. The object scanner of claim 1, further comprising:
a non-transitory memory configured to store a plurality of color filter patterns.

6. The object scanner of claim 5, wherein to separate the image data into the two or more channels, the image processor is configured to:
obtain, from the memory, two or more color filter patterns, wherein one of the color filter patterns includes pixels of two or more different colors; and
for each of the obtained color filter patterns, apply the color filter pattern to the image data produced by the color image sensor array to produce a channel of image data corresponding to the applied color filter pattern.

7. The object scanner of claim 1, wherein:
to output the image data corresponding to the particular channel, the image processor is configured to:
combine the image data in the two or more channels to produce a set of monochrome image data, and
output the set of monochrome image data; and
to analyze the respective image data to determine the contrast of the respective image data, the image processor is configured to:
determine a contrast of the set of monochrome image data.

8. The object scanner of claim 7, wherein to combine the image data, the image processor is configured to:
apply a respective coefficient to the respective image data in each of the two or more channels; and
based on the applied coefficients, combine the image data in the two or more channels to produce the set of monochrome image data.

9. The object scanner of claim 8, further comprising:
a non-transitory memory configured to store a plurality of sets of coefficients.

10. The object scanner of claim 9, wherein to apply a respective coefficient to the respective image data in each of the two or more channels, the image processor is configure to:
obtain, from the memory, a particular set of coefficients stored at the non-transitory memory; and
apply the obtained set of coefficients to the respective image data in each of the two or more channels.

11. The object scanner of claim 10, wherein:
the color image sensor array is configured to produce a plurality of frames of image data; and the image processor is configured to:
obtain a first set of coefficients stored at the non-transitory memory to apply to a first frame of plurality of frames; and
obtain a second set of coefficients stored at the non-transitory memory to apply to a second frame of plurality of frames.

12. The object scanner of claim 10, wherein to obtain the particular set of coefficients, the object scanner is configured to:
decode a first set of image data produced by the imaging array, the first set of image data including a parameter barcode;
obtain, from the non-transitory memory, a set of coefficients corresponding to the parameter barcode.

13. The object scanner of claim 8, wherein:
the color image sensor array is configured to produce a plurality of frames of image data; and
to apply the respective coefficient to the respective image data in each of the two or more channels, the image processor is configured to:
for a first frame of image data:
apply a first set of coefficients to the respective image data in each of the two or more channels,
based on the first set of coefficients, combine the image data in the two or more channels to produce a first set of monochrome image data, and
analyze the first set of monochrome image data to determine a coefficient adjustment to improve a contrast of produced monochrome image data; and
for a subsequent frame of image data:
based upon the determined coefficient adjustment, apply a second set of coefficients to the respective image data in each of the two or more channels, and
based on the second set of coefficients, combine the image data in the two or more channels to produce a second set of monochrome image data.

14. The object reader of claim 1, further comprising:
a decoder configured to decode the selected set of image data.

15. The object reader of claim 14, wherein the decoder is configured to detect a presence of a barcode within the outputted set of image data.

16. The object reader of claim 1, further comprising:
a machine vision module configured to detect a presence of one or more target features within the outputted set of image data.

17. The object reader of claim 16, wherein the target feature is a pin soldering quality or a crack in an object surface.

18. A method of processing image data comprising:
producing, via a color image sensor array, image data representative of an imaging field of view;
separating, via an image processor, the produced image data into two or more channels of image data;
for each of the channels of image data, analyzing, via the image processor, the respective image data to determine a contrast of the respective image data;
selecting, via the image processor, a particular channel of the two or more channels that has the highest contrast; and
outputting, via the image processor, the image data corresponding to the particular channel.

19. The method of claim 18, wherein:
the color image sensor array senses light in the infrared (IR) spectrum, and
separating the image data into two or more channels of image data comprises separating IR data from the imaging data produced by the color image sensor array into an IR channel.

20. The method of claim 18, wherein separating the image data into two or more channels of image data comprises separating the image data into a red channel, a blue channel, and a green channel.

21. The method of claim 18, wherein:
outputting the image data corresponding to the particular channel comprises:
combining the image data in the two or more channels to produce a set of monochrome image data, and
outputting the set of monochrome image data; and
analyzing the respective image data to determine a contrast of the respective image data comprises:
determining a contrast of the set of monochrome image data.

22. The method of claim 21, wherein combining the image data comprises:
applying a respective coefficient to the respective image data in each of the two or more channels; and
based on the applied coefficients, combining the image data in the two or more channels to produce the set of monochrome image data.

23. The method of claim 22, wherein applying a respective coefficient to the respective image data in each of the two or more channels comprises:
obtaining, from a memory, a particular set of coefficients stored thereat; and
applying the obtained set of coefficients to the respective image data in each of the two or more channels.

24. The method of claim 23, wherein:
producing the image data comprises producing a plurality of frames of image data; and
obtaining the particular set of coefficients comprises:
obtaining a first set of coefficients stored at the memory to apply to a first frame of plurality of frames; and
obtaining a second set of coefficients stored at the memory to apply to a second frame of plurality of frames.

25. The method of claim 22, wherein:
producing the image data comprises producing a plurality of frames of image data; and
applying the respective coefficient to the respective image data in each of the two or more channels comprises:
for a first frame of image data:
applying a first set of coefficients to the respective image data in each of the two or more channels,
based on the first set of coefficients, combining the image data in the two or more channels to produce a first set of monochrome image data, and
analyzing the first set of monochrome image data to determine a coefficient adjustment to improve a contrast of produced monochrome image data; and
for a subsequent frame of image data:
based upon the determined coefficient adjustment, applying a second set of coefficients to the respective image data in each of the two or more channels, and
based on the second set of coefficients, combining the image data in the two or more channels to produce a second set of monochrome image data.
